(19) United States
(12) Patent Application Publication
(10) Pub. No.: US 2026/0307251 A1
(43) Pub. Date: Oct. 8, 2026

(54) CONTROL METHOD, CONTROL APPARATUS, ROBOT SYSTEM, METHOD FOR MANUFACTURING A PRODUCT, AND RECORDING MEDIUM

(71) Applicant: CANON KABUSHIKI KAISHA, Tokyo (JP)

(72) Inventor: GEN KIMURA, Kanagawa (JP)

(21) Appl. No.: 19/577,479

(22) Filed: Mar. 25, 2026

(30) Foreign Application Priority Data
Apr. 8, 2025 (JP) 2025-063611

(51) Int. Cl. B25J 9/16

(52) U.S. Cl. CPC B25J 9/1664; B25J 9/1653

(57) ABSTRACT

A control method is provided for controlling an operation of a robot in accordance with a speed command for the robot moving in a path. The control method includes: in a case where a predetermined command is received while the robot is operating in accordance with the path, obtaining a parameter set in accordance with a first position downstream of a position where the robot is positioned when the predetermined command is received; obtaining a new speed command satisfying a dynamic restriction based on the obtained parameter set; and controlling, in accordance with the new speed command, the operation of the robot after receiving the predetermined command.

### BACKGROUND

### Field of the Technology

The present disclosure relates to robot technology.

### Description of the Related Art

In various industries such as the manufacturing industry and the service industry, various works are performed by systems including robots. The demand for a cooperative robot as a robot used in such systems has been rising. The cooperative robot performs a work in the same work space as people, and is thus expected to be used in a wide variety of fields. For such a robot to smoothly perform a cooperative work with a person, an advanced sensor technique and an advanced control technique are desired.

In the operation of the robot, emergency stop of the robot and control based on safety limited speed (SLS) are frequently performed. Japanese Patent Application Laid-Open No. H06-35527 discloses a method for performing an emergency stop of a robot. The emergency stop is a function to immediately stop the operation of the robot in the time of emergency, and SLS is a function to quickly adjust the speed of the robot in accordance with the change in the work environment and the situation.

The functions such as emergency stop and SLS can be causes of increase in the load on the robot. Particularly, since the cooperative robot works near a person, there is a tendency that the frequency of the emergency stop and SLS thereof is higher than a robot used in an environment separated from the work space of a person. The load on the robot increases in the case where the frequency of a predetermined command such as emergency stop or SLS increases, and therefore improvement has been desired.

### SUMMARY

The present disclosure provides a technique advantageous for reducing the load on a robot.

According to a first aspect of the present disclosure, there is provided a control method for controlling an operation of a robot in accordance with a speed command for the robot moving in a path. The control method includes: in a case where a predetermined command is received while the robot is operating in accordance with the path, obtaining a parameter set in accordance with a first position downstream of a position where the robot is positioned when the predetermined command is received; obtaining a new speed command satisfying a dynamic restriction based on the obtained parameter set; and controlling, in accordance with the new speed command, the operation of the robot after receiving the predetermined command.

According to a second aspect of the present disclosure, there is provided a control method for controlling an operation of a robot in accordance with a trajectory of the robot moving in a path. The control method includes: in a case where a predetermined command is received while the robot is operating in accordance with the path, obtaining a parameter set in accordance with a first position downstream of a position where the robot is positioned when the predetermined command is received; obtaining a new trajectory satisfying a dynamic restriction on a basis of the obtained parameter set; and controlling, in accordance with the new trajectory, the operation of the robot after receiving the predetermined command.

According to a third aspect of the present disclosure, there is provided a control apparatus configured to control an operation of a robot in accordance with a speed command for the robot moving in a path. The control apparatus is configured to: in a case where a predetermined command is received while the robot is operating in accordance with the path, obtain a parameter set in accordance with a first position downstream of a position where the robot is positioned when the predetermined command is received; obtain a new speed command satisfying a dynamic restriction on a basis of the obtained parameter set; and control, in accordance with the new speed command, the operation of the robot after receiving the predetermined command.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram of a robot system serving as an example of a system according to an embodiment.

FIG. 1B is an explanatory diagram of a robot according to the embodiment.

FIG. 2 is a block diagram of the robot system according to the embodiment.

FIG. 3 is a flowchart of a control method for the robot according to the embodiment.

FIG. 4 is a flowchart of the control method for the robot according to the embodiment.

FIG. 5A is an explanatory diagram of a path according to the embodiment.

FIG. 5B is an explanatory diagram of a plurality of evaluation points in the path according to the embodiment.

FIG. 5C is an explanatory diagram of a trajectory according to the embodiment.

FIG. 5D is an explanatory diagram of a new trajectory according to the embodiment.

FIG. 6 is an explanatory diagram of a universal cam curve according to the embodiment.

### DESCRIPTION OF THE EMBODIMENTS

Embodiments of the present disclosure will be described in detail below with reference to drawings. The configuration of the following embodiment, for example, details of the configuration may be appropriately modified for implementation by one skilled in the art within the gist of the present disclosure. In addition, in the drawings referred to in the description of the following embodiment, it is assumed that elements denoted by the same reference signs have substantially the same function unless described otherwise. In addition, these drawings are schematically expressed for the sake of convenience of illustration and description, and therefore shape, size, position, and the like do not necessarily strictly match between drawings.

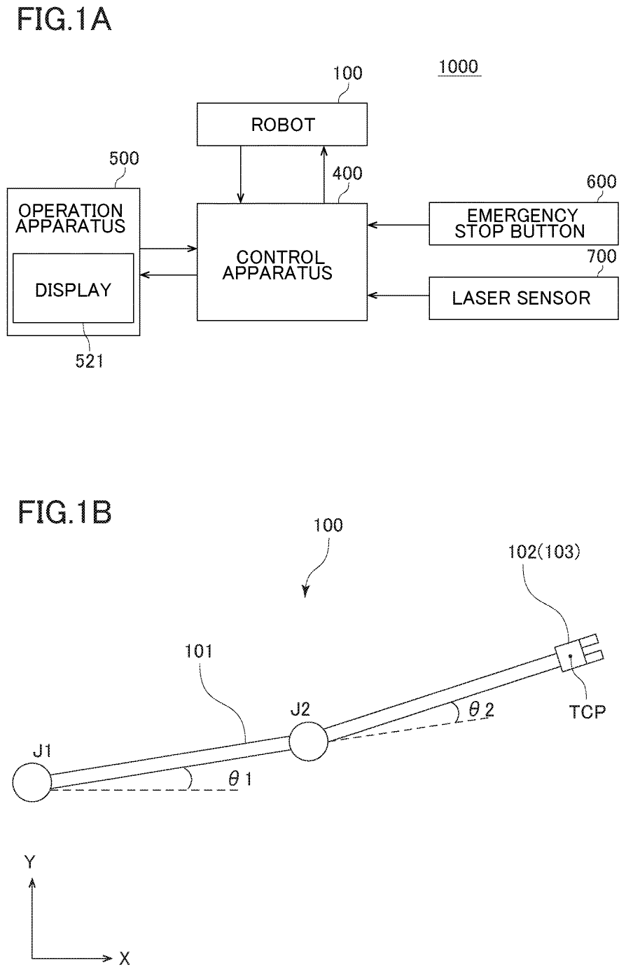

FIG. 1A is a block diagram of a robot system 1000 serving as an example of a system according to the embodiment. The robot system 1000 includes a robot 100, a control apparatus 400, an operation apparatus 500, an emergency stop button 600, and a laser sensor 700. The robot 100 is disposed on, for example, a stand. The stand may be a movable stand that moves in a work space such as a factory, or a fixed stand fixed to the floor of the factory or the like.

FIG. 1B is an explanatory diagram of the robot 100 according to the embodiment. The robot 100 is, for example, an industrial robot. The robot 100 can be, for example, a cooperative robot that works in cooperation with a person such as a worker (user). The robot 100 manufactures a manufactured product serving as an example of a product by performing a work by itself or in cooperation with another robot or a person. The product may be a final product or an intermediate product.

The root end of the robot 100 is a fixed end, and is fixed to the stand. The distal end of the robot 100 is a free end. That is, as a result of operation of the robot 100, a distal end portion 103 serving as an example of a predetermined portion of the robot 100 moves to an arbitrary position.

The robot 100 includes a robot arm 101, and a robot hand 102 serving as an example of an end effector. The distal end portion 103 of the robot 100 is a robot hand 102 in the present embodiment. The robot hand 102 is attached to the robot arm 101, for example, to the distal end of the robot arm 101.

The robot arm 101 is a multi-axis robot arm. The robot arm 101 includes a plurality of links, and the plurality of links are coupled together via a plurality of joints. Various kinds of joints such as rotary joints, linear joints, or ball joints can be used as the joints. Each joint may be configured to be actively operated by a drive source such as a motor, or may be configured to operate passively without including a drive source. In addition, various types of robot arms such as a serial link type in which a plurality of links are coupled in series, or a parallel link type in which a plurality of links are coupled in parallel can be used as the robot arm 101. A case where each joint of the robot arm 101 is a rotary joint and the robot arm 101 is a robot arm of a serial link type will be described below as an example.

In the example of FIG. 1B, the robot arm 101 includes two joints J1 and J2. In each of the joints J1 and J2, a motor serving as a drive source, a reduction gear, a torque sensor, and an angle sensor are provided. The robot 100 can take various postures as a result of the motor provided in each of the joints J1 and J2 driving a corresponding link via the reduction gear.

The robot hand 102 is configured to be capable of holding a workpiece. The robot hand 102 includes, for example, two finger portions. To be noted, the robot hand 102 may be configured to be capable of holding a workpiece, and for example, may include a suction mechanism capable of holding a workpiece by suction attraction instead of a finger portion. In a manufacturing line for manufacturing a product, the robot 100 can perform, by holding a workpiece by the robot hand 102, a conveyance work, an assembly work of coupling the workpiece to another workpiece, or perform a processing work of a workpiece by gripping a tool.

A tool center point (TCP) that is a control point that moves together with the distal end portion 103 is defined on the distal end portion 103 of the robot 100, and by designating the position and posture of the TCP, the robot 100 can be moved to various postures.

The number of joints, that is, the degree of freedom of the robot arm 101 is 2. To be noted, the number of joints is not limited to 2, and may be 2 or more, for example, 6.

In the case where a parameter indicating the degree of freedom of the robot arm 101 is referred to as a joint angle and the joint angles of the two joints J1 and J2 of the robot arm 101 are respectively denoted by θ1 and θ2, the joint angle of the robot arm 101 is expressed by q=(θ1, θ2) T. Therefore, in a joint space, a plurality of joint angles (or linear movement positions of joints) can be expressed as one point, and the control can be also defined by the two joint angles in the joint space.

In addition, in a task space or the joint space, a teaching point that the control point follows is set. The teaching point is set by parameters in the task space or the joint space. In the case of the task space, the teaching point is constituted by three pieces of information indicating a position and three pieces of information indicating a posture. The teaching point defined in the task space can be converted into a teaching point defined in the joint space. For example, in the case of a two-axis robot, the teaching point defined in the joint space is constituted by information of two joint positions (joint angles).

The processing of converting the teaching point defined in the task space into a teaching point defined in the joint space is performed on the basis of, for example, inverse kinematics calculation of the robot 100. In addition, the processing of converting the teaching point defined in the joint space into a teaching point defined in the task space is performed on the basis of, for example, forward kinematics calculation of the robot 100.

The robot 100 is connected to the control apparatus 400 via a cable. The control apparatus 400 controls the operation of the robot 100. The operation apparatus 500 is connected to the control apparatus 400. The operation apparatus 500 is an apparatus that the worker (user) can operate, and is, for example, a teaching pendant with which teaching for the robot 100 can be performed. The operation apparatus 500 receives input of input data from the worker (user), and transmits the received data to the control apparatus 400. The operation apparatus 500 includes a display 521, and the display 521 displays the robot arm 101 and the work space in three-dimensional (3D) graphics. As a result of this, a person such as the worker (user) can check a generated trajectory of the robot 100 by looking at the display 521.

The emergency stop button 600 is an example of a predetermined button, and a predetermined command is issued to the control apparatus 400 when the emergency stop button 600 is operated. The emergency stop button 600 is a button switch that can be operated by a person, and when operated by a person, transmits an emergency stop signal indicating an emergency stop command for stopping the robot 100 to the control apparatus 400.

The laser sensor 700 is an example of a predetermined sensor, and issues the predetermined command to the control apparatus 400 when detecting a person, an object, or the like. The laser sensor 700 is disposed around the robot 100, and transmits a detection signal indicating a detection command to the control apparatus 400 when a person, an object, or the like enters a region where detection by the laser sensor 700 can be performed.

The robot 100 is provided with a servo controller including firmware for controlling motors. The control apparatus 400 controls the operation of the robot 100 by giving an operation command to the servo controller.

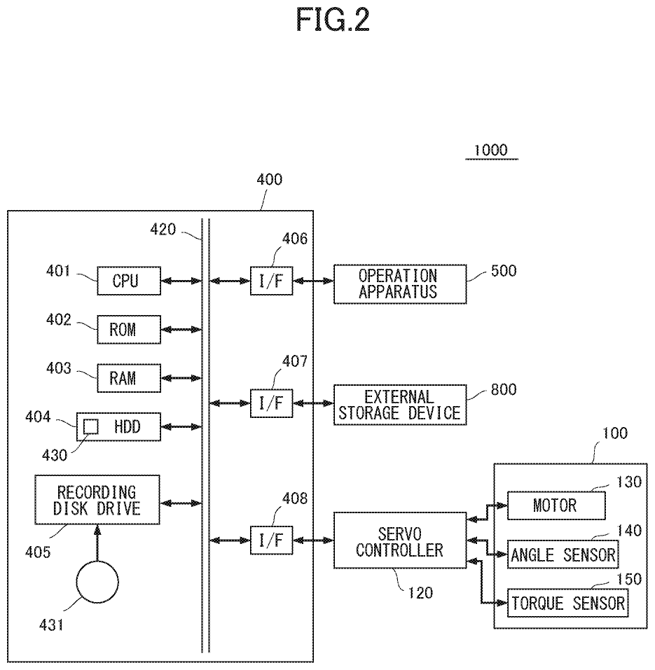

FIG. 2 is a block diagram of a robot system 1000 according to the embodiment. The joints J1 and J2 of the robot arm 101 are each provided with a motor 130, an angle sensor 140, and a torque sensor 150. To be noted, FIG. 2 illustrates the configuration of one of the joints J1 and J2 in the robot 100.

The control apparatus 400 is constituted by a computer, and includes a central processing unit (CPU) 401 serving as a processor. The CPU 401 is also an example of a controller. In addition, the CPU 401 is also an example of a processing portion. In addition, the control apparatus 400 includes a read-only memory (ROM) 402, a random access memory (RAM) 403, and a hard disk drive (HDD) 404 as examples of storage portions. In addition, the control apparatus 400 includes a recording disk drive 405, and a plurality of input/output interfaces (I/F) 406 to 408. The CPU 401 is connected to the ROM 402, the RAM 403, the HDD 404, the recording disk drive 405, and the input/output interfaces 406 to 408 via a bus 420. The ROM 402 stores a basic program loaded by the CPU 401 when booting up a computer. The RAM 403 is a storage device that temporarily stores various data such as a calculation result of the CPU 401. The HDD 404 is a storage device that stores the calculation result of the CPU 401, various data obtained from the outside, and the like. The HDD 404 stores a program 430 for causing the CPU 401 to execute calculation processing and control processing. The CPU 401 executes a control method described below on the basis of the program 430 recorded (stored) in the HDD 404. The recording disk drive 405 can read various data, programs, and the like stored in a recording disk 431.

The input/output interface 406 is connected to the operation apparatus 500. The CPU 401 obtains input data (input information) from the operation apparatus 500 via the input/output interface 406 and the bus 420. The input/output interface 407 is configured such that an external storage device 800 serving as a storage device such as a rewritable nonvolatile memory, an external HDD, or the like is connectable thereto.

The input/output interface 408 is connected to a servo controller 120. The servo controller 120 is connected to the motor 130, the angle sensor 140, and the torque sensor 150 of each joint of the robot arm 101. The motor 130 is, for example, a brushless direct current (DC) motor or an alternating current (AC) motor, and rotationally drives corresponding one of the plurality of joints. The angle sensor 140 is, for example, a rotary encoder provided in the motor 130 and configured to be capable of detecting the rotational angle of the motor 130. The torque sensor 150 is provided in corresponding one of the plurality of joints, and is configured to be capable of detecting the torque acting on the corresponding one of the joints.

The CPU 401 can obtain angle information from the angle sensor 140 via the servo controller 120, the input/output interface 408, and the bus 420, and can obtain torque information from the torque sensor 150. The servo controller 120 may convert the angle of the motor 130 detected by using the angle sensor 140 into angle information of the corresponding one of the joints by dividing the angle by a reduction ratio of an unillustrated reduction gear, and transmit the angle information to the CPU 401.

The CPU 401 outputs the data of a command value corresponding to each joint to the servo controller 120 via the bus 420 and the input/output interface 408 at a predetermined time interval.

The HDD 404 is also a non-transitory computer-readable recording medium. Although the HDD 404 stores the program 430 in the present embodiment, the configuration is not limited to this. The program 430 may be stored in any recording medium as long as the recording medium is a non-transitory computer-readable recording medium. For example, as the recording medium for supplying the program 430, a flexible disk, a hard disk, an optical disk, a magneto-photo disk, a magnetic tape, or a nonvolatile memory can be used. Examples of the optical disk include disk media such as a Blu-ray disk, a digital versatile disk (DVD), and a compact disk (CD). Examples of the nonvolatile memory include storage devices such as a universal serial bus (USB) memory, a memory card, a ROM, or a solid state device (SSD). In addition, the program 430 may be obtained via a network.

The CPU 401 of the control apparatus 400 is configured to be capable of executing a first mode and a second mode. The first mode is a mode in which the operation of the robot 100 is controlled in accordance with a first trajectory (trajectory TR1 that will be described later). The second mode is a mode in which a second trajectory (trajectory TR2 that will be described later) when a predetermined command is received from the emergency stop button 600, the laser sensor 700, or the like while the robot 100 is operating in accordance with the first trajectory, and the operation of the robot 100 is controlled in accordance with the second trajectory.

Here, signs in the formulae are defined as follow. To be noted, in the formulae, bold letters indicate vectors.
t: time
S: mediator variable of interplated path
q: joint angle of robot arm

$$\dot{q} = \frac{dq ( s ( t ) )}{dt} :$$

derivative of joint angle of robot arm with respect to time (joint angular velocity)

$$\ddot{q} = \frac{{d}^{2} q ( s ( t ) )}{{dt}^{2}} :$$

second derivative of joint angle of robot arm with respect to time (joint angular acceleration)

$$\text{?} = \frac{{d}^{3} q ( s ( t ) )}{{dt}^{3}} :$$

third derivative of joint angle of robot arm with respect to time (jerk)

$${q}^{′} = \frac{dq ( s )}{ds} :$$

derivative of joint angle of robot arm with respect to s

$${q}^{″} = \frac{{d}^{2} q ( s )}{{ds}^{2}} :$$

second of joint angle of robot arm with respect to s

$${q}^{′′′} = \frac{{d}^{3} q ( s )}{{ds}^{3}} :$$

third derivative of joint angle of robot arm with respect to s

In the description below, time derivative is expressed by (·).

Generating a trajectory of the robot 100 also means generating a path in which the control point of the robot 100 moves and a speed command of the control point of the robot 100 following the path. Here, the speed command is data of speed in the entire path from a start point to an end point. A coordinate value s is defined in the path, and the equation of motion of the robot 100 is expressed by the following formula (1) by using the coordinate value s.

$$τ = M ( q ) \dot{q} + C ( q , \dot{q} ) \dot{q} + G ( q ) \qquad ( 1 )$$

Here, M represents a mass matrix, C represents a Coriolis term, G represents a weight term, and t represents a joint torque. Next, the joint angular velocity and the joint angular acceleration of the robot 100 are converted as in the formulae (2) and (3) below.

$$\dot{q} ( s ) = {q}^{′} ( s ) \dot{s} \qquad ( 2 )$$

$$\ddot{q} ( s ) = {q}^{′} ( s ) \ddot{s} + {q}^{″} ( s ) {\dot{s}}^{2} \qquad ( 3 )$$

In the formula (2), the joint angular velocity is divided into a vector q(s) indicating the position of the control point moving in the path, and a speed s(·) of the control point moving in the path. That is, in the case where the path that the control point follows is determined, considering only the speed of the control point moving in the path is enough, and this can be treated as a simple problem in which the direction the TCP moves in does not need to be considered. The same applies to the formula (3) indicating the joint angular acceleration.

The formula (4) is obtained by substituting the formulae (2) and (3) for terms in the formula (1).

$$τ ( s ) = m ( s ) \ddot{s} + c ( s ) {\dot{s}}^{2} + g ( s ) \qquad ( 4 )$$

To be noted, the formulae (5), (6), and (7) are applied to the formula (4).

$$m ( s ) = M ( q ( s ) ) {q}^{′} ( s ) \qquad ( 5 )$$

$$c ( s ) = M ( q ( s ) ) {q}^{″} ( s ) + C ( q ( s ) , {q}^{′} ( s ) ) {q}^{′} ( s ) \qquad ( 6 )$$

$$g ( s ) = G ( q ( s ) ) \qquad ( 7 )$$

As a result of the conversion described above, “obtaining a movement speed of the control point in the determined path to optimize the operation time while satisfying the dynamic restriction” can be replaced by “obtaining s(t) that optimizes the operation time while satisfying the dynamic restriction”.

By obtaining s(t) indicating the relationship between s and the time t, the operation time of the control point moving in the path is determined. In addition, since s(t) is calculated by integrating s(·), the trajectory is calculated by obtaining s(·).

Here, considering a trajectory in which the operation of the robot 100 starts at t=0 and the operation of the robot 100 is finished at t=T, it is assumed that s (0)=0≤s≤1=s(T) holds. In addition, it is assumed that t∈[0, T] and s(·)>0 hold.

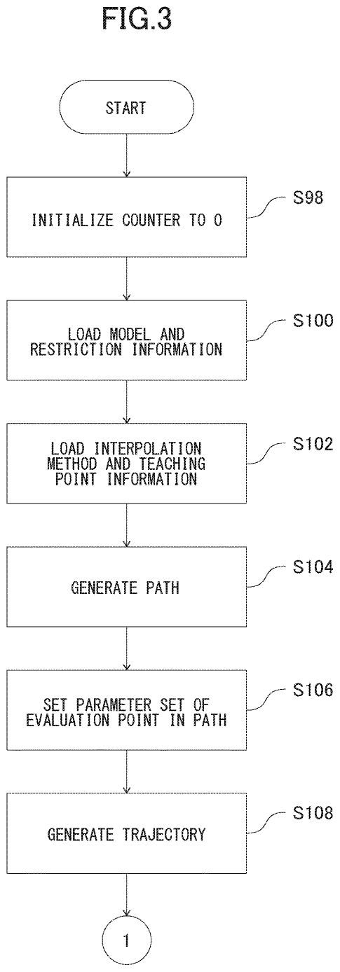

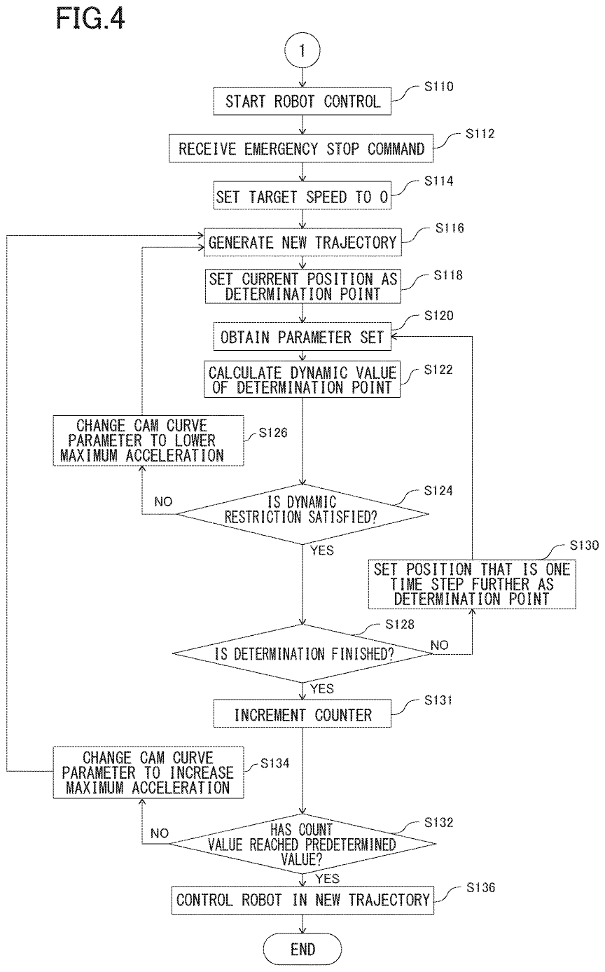

FIGS. 3 and 4 are each a flowchart of a control method for the robot 100 according to the embodiment. The control processing of the robot arm 101 will be mainly described below.

In step S98, the CPU 401 initializes a counter that counts the number of generated trajectories to 0.

In step S100, the CPU 401 loads, from a storage device such as the HDD 404, a model of the robot arm 101 and information of a dynamic restriction in the work space where the robot arm 101 operates.

The model of the robot arm 101 is design information of parts constituting the robot 100, and includes a moment of inertia of each link, a mass of each link, a position and posture of each link, the number of axes of the robot arm 101, and the like.

The dynamic restriction defines physical restriction of the robot 100, and includes at least one of a joint torque restriction indicating the range of torque of the joint, a joint angular velocity restriction indicating the range of angular velocity of the joint, a joint angular acceleration restriction indicating the range of angular acceleration of the joint, a jerk restriction indicating the range of jerk of the joint, a speed restriction indicating the range of speed of the TCP, and an acceleration restriction indicating the range of acceleration of the TCP.

Next, in step S102, the CPU 401 loads information of a teaching point of the robot arm 101 from a storage device such as the HDD 404. The teaching point of the robot arm 101 is determined in accordance with, for example, the position and posture of the TCP, or the joint angle. The position and posture of the TCP can be converted into the joint angle of the robot arm 101 by inverse kinematics calculation. In addition, the joint angle of the robot arm 101 can be converted into the position and posture of the TCP by forward kinematics calculation. In addition, the CPU 401 loads information of a method for interpolating teaching points from a storage device such as the HDD 404. Examples of the interpolation methods include a method of performing interpolation in the task space and a method of performing interpolation in the joint space, but the interpolation methods are not limited to these.

Next, in step S104, the CPU 401 generates a path for the control point of the robot 100 by interpolating a plurality of teaching points. The path is a trajectory of the control point. The trajectory of the control point is a trajectory of the joint angle of the robot arm 101 in the joint space, or a trajectory of the TCP of the robot 100 in the task space. To be noted, in the present embodiment, information of a path including information of a speed command will be referred to as a trajectory, and is distinguished from information of a path not including information of a speed command.

In which of the joint space and the task space the path is generated differs depending on the interpolation method. For example, the path can be interpolated in the joint space in the case of joint interpolation, and the path can be interpolated in the task space in the case of moving the TCP linearly or circularly. Examples of the method for interpolating the teaching points include spline interpolation, B-spline interpolation, Bezier curve, linear interpolation, and circular interpolation. The position in the path is indicated by a mediator variable. In the case where the dynamic restriction includes a jerk restriction, the path needs to be in the class C3 with respect to the mediator variable. For example, in the case of a quartic B-spline curve, the path is in the class C3 with respect to the mediator variable.

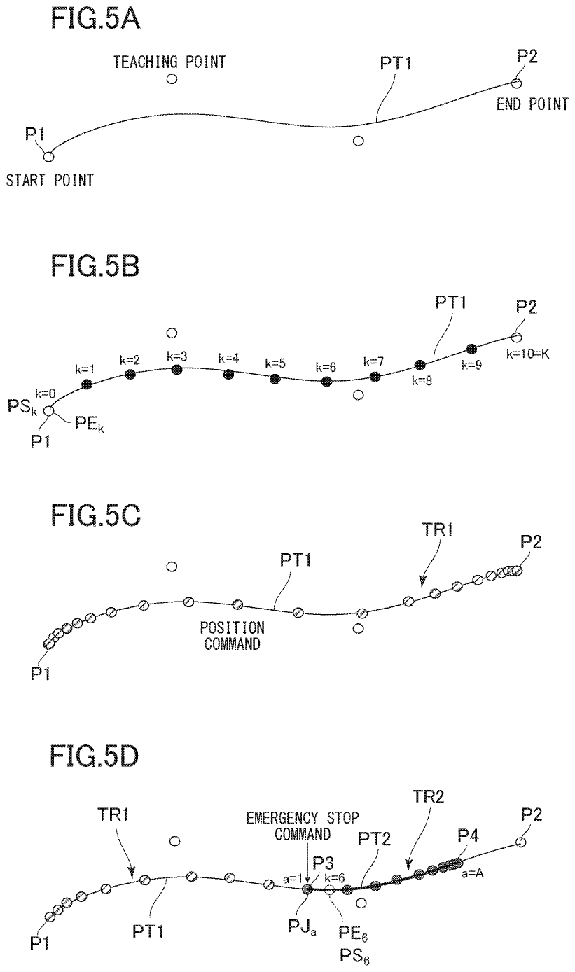

FIG. 5A is an explanatory diagram of a path according to the embodiment. FIG. 5A illustrates an example in which the path is generated by using a B-spline curve. A case where B-spline interpolation is performed will be described below as an example. As illustrated in FIG. 5A, a path PT1 from a start point (start position) P1 to an end point (end position) P2 is generated. The start point P1 is an example of a third position, and the end point P2 is an example of a fourth position. The path PT1 is an example of a first path.

FIG. 5B is an explanatory diagram of a plurality of evaluation points ((K+1) points) PE₀ to PE_{K} in the path PT1 according to the embodiment. In step S106, the CPU 401 defines the plurality of evaluation points PE₀ to PE_{K} in the path PT1. Then, the CPU 401 calculates a parameter set PS_{K} including a plurality of parameters for each of the plurality of evaluation points PE₀ to PE_{K} in the path PT1, and thus sets a plurality of parameter sets PS₀ to PS_{K} respectively corresponding to the plurality of evaluation points PE₀ to PE_{K}. Here, the evaluation point PE_{K} is an example of an evaluation position. The evaluation position may be referred to as a second position in some cases. k is an integer from 0 to K (0≤k≤K). K is a positive integer, and is 10 in the example of FIG. 5B.

To be noted, although the plurality of parameters included in each of the plurality of parameter sets PS₀ to PS_{K} are calculated by the CPU 401 in the present embodiment, the configuration is not limited to this. For example, the plurality of parameters included in each of the plurality of parameter sets PS₀ to PS_{K} may be calculated by an unillustrated processor different from the CPU 401. In addition, although a case where the plurality of parameter sets PS₀ to PS_{K} are each constituted by a plurality of parameters will be described as an example, the configuration is not limited to this, and the plurality of parameter sets PS₀ to PS_{K} may be each constituted by one parameter. That is, the plurality of parameter sets PS₀ to PS_{K} are each constituted by at least one parameter.

FIG. 5B illustrates an example in which a plurality of ((K+1)) evaluation points PE₀ to PE_{K} are evenly assigned in the path. The CPU 401 calculates the following parameters for each of the plurality of evaluation points PE₀ to PE_{K}.

The differential value of a joint angle vector q with respect to s at a point k is expressed by the formula (8).

$${q}^{′ k} = \frac{dq}{ds} ( k ) \qquad ( 8 )$$

The differential value of the joint angle vector q with respect to s at a point (k+1/2) is expressed by the formula (9).

$${q}^{′ k + \frac{1}{2}} = \frac{dq}{ds} ( k + \frac{1}{2} ) \qquad ( 9 )$$

The second differential value of the joint angle vector q with respect to s at the point k is expressed by the formula (10).

$${q}^{″ k} = \frac{{d}^{2} q}{{ds}^{2}} ( k ) \qquad ( 10 )$$

The second differential value of the joint angle vector q with respect to s at a point (k+1/2) is expressed by the formula (11).

$${q}^{″ k + \frac{1}{2}} = \frac{{d}^{2} q}{{ds}^{2}} ( k + \frac{1}{2} ) \qquad ( 11 )$$

The third differential value of the joint angle vector q with respect to s at the point k is expressed by the formula (12).

$${q}^{′′′ k} = \frac{{d}^{3} q}{{ds}^{3}} ( k ) \qquad ( 12 )$$

The third differential value of the joint angle vector q with respect to s at a point (k+1/2) is expressed by the formula (13).

$${q}^{′′′ k + \frac{1}{2}} = \frac{{d}^{3} q}{{ds}^{3}} ( k + \frac{1}{2} ) \qquad ( 13 )$$

A mass matrix at the point (k+1/2) is expressed by the formula (14).

$${M}^{k + \frac{1}{2}} \qquad ( 14 )$$

A Coriolis term at the point (k+1/2) is expressed by the formula (15).

$${C}^{k + \frac{1}{2}} \qquad ( 15 )$$

A weight term at the point (k+1/2) is expressed by the formula (16).

$${G}^{k + \frac{1}{2}} \qquad ( 16 )$$

A mass matrix in the s space is expressed by the formula (17).

$${m}^{k + \frac{1}{2}} = {M}^{k + \frac{1}{2}} {q}^{′ k + \frac{1}{2}} \qquad ( 17 )$$

A Coriolis term in the s space is expressed by the formula (18).

$${c}^{k + \frac{1}{2}} = {M}^{k + \frac{1}{2}} {q}^{″ k + \frac{1}{2}} + {C}^{k + \frac{1}{2}} {q}^{′ k + \frac{1}{2}} \qquad ( 18 )$$

A weight term in the s space is expressed by the formula (19).

$${g}^{k + \frac{1}{2}} = {G}^{k + \frac{1}{2}} \qquad ( 19 )$$

As described above, the CPU 401 calculates the plurality of parameters corresponding to each of the evaluation points PE₀ to PE_{K} in advance before starting the control of the operation of the robot 100 (before step S110), and stores the parameters in a storage device such as the HDD 404. By performing calculation of a high computational load like this in advance, the CPU 401 does not need to calculate the plurality of parameters corresponding to each of the evaluation points PE₀ to PE_{K} during control of the robot 100, and thus can respond quickly when receiving a command for emergency stop or SLS. To be noted, these parameters may be displayed or editable through a user interface.

FIG. 5C is an explanatory diagram of the trajectory TR1 according to the embodiment. In step S108, the CPU 401 generates the trajectory TR1 of the robot 100 by using the formula (20). The trajectory TR1 is an example of a first trajectory. For example, the CPU 401 may generate the trajectory TR1 by calculating s(t) from s(·)(s) calculated by shortest time control, obtaining q(s), and obtaining the joint angle for each of a certain time Δt. To be noted, s(0)=0 holds. As described above, the position command is generated for each certain time Δt.

$$s ( t + Δ t ) = s ( t ) + \dot{s} ( s ( t ) ) Δ t \qquad ( 20 )$$

FIG. 5C illustrates an example of the generated trajectory TR1. To be noted, in the generation of the trajectory TR1, the parameters described above do not need to be used, and the CPU 401 may generate the trajectory TR1 by a different algorithm. Here, since the position command is issued to the servo controller 120 each certain time Δt, the trajectory TR1 includes a speed command.

In step S110, the CPU 401 starts the control of the operation of the robot 100 in accordance with the trajectory TR1 generated in step S108.

It is assumed that the CPU 401 has received an emergency stop command in step S112. To be noted, although a case where the predetermined command received by the CPU 401 is an emergency stop command will be described as an example, the configuration is not limited to this, and the predetermined command received by the CPU 401 may be, for example, an SLS command indicating acceleration, deceleration, or stop by SLS, or a detection command from the laser sensor 700. That is, the emergency stop command, the SLS command, and the detection command are each an example of a predetermined command.

FIG. 5D is an explanatory diagram of a new trajectory TR2 according to the embodiment. In the present embodiment, in the case where a predetermined command is received while the robot 100 is operating in accordance with the path PT1, the CPU 401 obtains a parameter set in accordance with a determination point PJₐ that is a position downstream of the position of the robot 100 at a timing when the predetermined command is received, and obtains the new trajectory TR2 (new speed command) satisfying the dynamic restriction on the basis of the obtained parameter set.

Although a case where when the CPU 401 has received an emergency stop command, the CPU 401 decelerates the robot 100 and stops the robot 100 at an end point P4 upstream of the end point P2 in the path PT1, that is, a case where the CPU 401 performs emergency stop of the robot 100 will be described as an example in the description below, the configuration is not limited to this. For example, this can be also applied to a case of performing an operation of decelerating the robot 100 along the path PT1 (that is, case of operating the robot 100 more slowly than in the trajectory TR1), or a case of performing an operation of accelerating the robot 100 along the path PT1. Alternatively, this can be applied to a case where the CPU 401 operates the robot 100 along a different path that does not overlap partially or entirely with the path PT1 when the predetermined command is received.

The CPU 401 obtains a start point P3 in the path PT1 where the control point of the robot 100 is positioned when the emergency stop command is received. The start point P3 is an example of a predetermined position (fifth position). The start point P3 is a position between the start point P1 and the end point P2 in the path PT1. To be noted, the CPU 401 may display a user interface on the display 521 of FIG. 1A, and in which position in the path PT1 the emergency stop command has been received may be displayed in the user interface.

In step S114, the CPU 401 sets a target speed to 0. To be noted, the target speed does not have to be 0, the ratio of the non-zero speed may be set, or a non-zero speed may be set. In addition, the CPU 401 may set the target speed as a speed in a direction opposite to the speed currently aimed at.

In step S116, by using a universal cam curve, the CPU 401 generates the new trajectory TR2 whose speed command is changed. The new trajectory TR2 is a trajectory for performing emergency stop of the robot 100. FIG. 5D illustrates the timing of the emergency stop command when the emergency stop command is received and the new trajectory TR2 that is generated.

In step S116, the new speed command is generated such that the operation speed of the robot 100 transitions from the speed at the time when the predetermined command such as the emergency stop command is received to the target speed (for example, 0) set in step S114. At this time, the new speed command is generated so as to transition in a curved line shape.

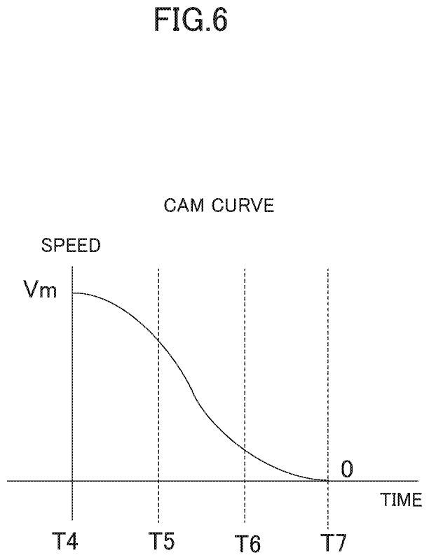

FIG. 6 is an explanatory diagram of a universal cam curve according to the embodiment. When changing the speed command, the CPU 401 generates the new trajectory TR2 for decelerating the robot 100 by using a deceleration portion of the universal cam curve illustrated in FIG. 6, but the configuration is not limited to this, and for example, the CPU 401 may generate the new trajectory TR2 for accelerating the robot 100 by using an acceleration portion of the universal cam curve.

Aₘₘ represents the absolute value of the maximum acceleration during deceleration in the universal cam curve. The cam curve is used by being multiplied by the speed command of the original trajectory TR1. Therefore, the maximum value Vₘ of the cam curve is set to 1. In addition, since the target speed set in step S116 is 0, the speed at a time T7 at the end is 0.

The following formulae (21), (22), and (23) hold in a section of T4≤t<T5.

$${C}_{5} = \frac{2 ( {T}_{5} - {T}_{4} )}{π} \qquad ( 21 )$$

$$p = \frac{t - {T}_{4}}{{C}_{5}} \qquad ( 22 )$$

$${V}_{4} = {V}_{m} \qquad ( 23 )$$

The new speed command is expressed by the following formula (24).

$$V ( t ) = {C}_{5} {A}_{mm} ( cos p - 1 ) + {V}_{4} \qquad ( 24 )$$

The following formula (25) holds in a section of T5≤t<T6.

$${V}_{5} = {C}_{5} {A}_{mm} + {V}_{4} \qquad ( 25 )$$

The new speed command is expressed by the following formula (26).

$$V ( t ) = - {A}_{mm} ( t - {T}_{5} ) + {V}_{5} \qquad ( 26 )$$

The following formulae (27), (28), and (29) hold in a section of T5≤t<T6.

$${V}_{6} = - {A}_{mm} ( {T}_{6} - {T}_{5} ) + {V}_{5} \qquad ( 27 )$$

$${C}_{7} = \frac{2 ( {T}_{7} - {T}_{6} )}{π} \qquad ( 28 )$$

$$p = \frac{t - {T}_{6}}{{C}_{7}} \qquad ( 29 )$$

The new speed command is expressed by the following formula (30).

$$V ( t ) = - {C}_{7} {A}_{mm} sin p + {V}_{6} \qquad ( 30 )$$

By using a cam curve, the new speed command is generated so as to transition smoothly without exceeding a designated maximum acceleration Aₘₘ. As a result of appropriately setting he maximum acceleration Aₘₘ, a sudden motion can be avoided, and thus smooth movement can be realized.

By multiplying a cam curve V (t) smoothly transitioning from 1 to 0 by s(·)(s) on the basis of a point in the path where the emergency stop command is received, the new trajectory TR2 (new speed command) in which the control point of the robot 100 smoothly stops is generated.

T4 in the cam curve is regarded as a time point when the emergency stop command is received, and T5 and T6 are set as time points when the jerk value of the cam curve is the largest.

$$s ( t + Δ t ) = s ( t ) + \dot{s} ( s ( t ) ) V ( t ) Δ t \qquad ( 31 )$$

As described above, in step S116, the new trajectory TR2, that is, the new speed command included in the new trajectory TR2 is obtained by using the cam curve. That is, the new trajectory TR2 (new speed command) is generated such that the operation speed of the robot 100 smoothly transitions from the speed when the predetermined command is received in step S112 to the target speed set in step S114 along the cam curve.

To determine whether or not the new trajectory TR2 exceeds the dynamic restriction, each of the plurality of positions downstream of the current position in the path PT1 will be referred to as a determination point PJₐ. The determination point PJₐ is an example of a determination position. The determination position may be also referred to as a first position. Here, a is an integer from 1 to A (1≤a≤A). In the case where the number of determination points is 1, A is 1, and in the case where the number of determination points is 2 or more, A is an integer of 2 or more. A case where the dynamic restriction includes a joint torque restriction and a jerk restriction will be described as an example below.

First, in step S118, the CPU 401 sets the start point P3 that is the current position as a determination point PJ₁. Here, the start point P3 that is the current position is a position where the CPU 401 receives the emergency stop command.

In step S120, the CPU 401 selects the evaluation point (for example, the evaluation point PE₆) closest to the determination point PJ₁ from the plurality of evaluation points PE₀ to PE_{K} in the path PT1 calculated in step S106, and obtains the parameter set PS₆ corresponding to the selected evaluation point PE₆. That is, the CPU 401 selects and obtains the parameter set PS₆ from the plurality of parameter sets PS₀ to PS_{K} corresponding to the plurality of evaluation points PE₀ to PE_{K}. The parameter set PS₆ is an example of a predetermined parameter.

To be noted, although the parameter set PS₆ corresponding to the evaluation point PE₆ closest to the determination point PJ₁ is obtained in the present embodiment, the configuration is not limited to this. For example, a predetermined parameter set including the plurality of parameters corresponding to the position of the determination point PJ₁ may be obtained by interpolation by an interpolation method such as linear interpolation. In this case, the predetermined parameter set is obtained by interpolation based on at least two parameter sets in the plurality of parameter sets PS₀ to PS_{K}. In this case, since interpolation calculation is performed, more time is required than in the case of simply selecting the predetermined parameter set, but the predetermined parameter is obtained in a shorter time than in the case of performing calculation for all the parameter sets PS₀ to PS_{K}. In this manner, a predetermined parameter set is obtained from the plurality of parameter sets PS₀ to PS_{K}.

In step S122, the CPU 401 calculates a dynamic value related to the robot 100 in the determination point PJ₁ by using the obtained parameter set PS₆.

In the present embodiment, since the dynamic restriction includes a joint torque restriction and a jerk restriction, the dynamic value related to the robot 100 is a torque value of each joint and a jerk value. To be noted, depending on the dynamic restriction, the dynamic value may be an angular velocity value of each joint, an angular acceleration value of each joint, a speed value of TCP, an acceleration value of TCP, or a dynamic value in the TCP.

When changing the speed, since the control is performed by setting a control cycle time Δt to a constant value, the difference Δs of s is not constant. The torque value and the jerk value need to be calculated in consideration of this.

A method for calculating the torque value will be described above. The current s value is converted into k. s is a floating-point number, but k is defined an integer. k is defined such that the formula (32).

$$k + \frac{1}{2} = s ( t ) K \qquad ( 32 )$$

j is defined such that the formula (33) holds.

$$k + \frac{1}{2} - j = ( s ( t - Δ t ) ) K \qquad ( 33 )$$

The torque value of each joint of the new trajectory TR2 is calculated by the formula (38) by the calculation of the following formulae (34), (35), (36), and (37).

$$Δ s = s ( t ) - s ( s ( t - Δ t ) ) \qquad ( 34 )$$

$${b}^{k + \frac{1}{2}} = {\dot{s}}^{2} ( s ( t ) ) \qquad ( 35 )$$

$${b}^{k + \frac{1}{2} - j} = {\dot{s}}^{2} ( s ( t - Δ t ) ) \qquad ( 36 )$$

$${b}^{′ k + \frac{1}{2}} = \frac{{b}^{k + \frac{1}{2}} - {b}^{k + \frac{1}{2} - j}}{Δ s} \qquad ( 37 )$$

$${τ}_{i}^{k + \frac{1}{2}} = {m}_{i}^{k + \frac{1}{2}} \frac{{b}^{′ k + \frac{1}{2}}}{2} + {c}_{i}^{k + \frac{1}{2}} {b}^{k + \frac{1}{2}} + {g}_{i}^{k + \frac{1}{2}} \qquad ( 38 )$$

A method for calculating the jerk value will be described below. k is defined to satisfy the formula (39).

$$k = s ( t ) K \qquad ( 39 )$$

Linear approximation of s is performed in a section of ±Δt, and l is defined to satisfy the formula (40).

$$k - l = ( s ( t - Δ t ) ) K \qquad ( 40 )$$

j is defined to satisfy the formula (41).

$$k + j = ( s ( t + Δ t ) ) K \qquad ( 41 )$$

The difference in s from t−Δt to t is obtained by the following formula (42).

$$Δ {s}_{1} = s ( t ) - s ( s ( t - Δ t ) ) \qquad ( 42 )$$

The difference in s from t+Δt to t is obtained by the following formula (43).

$$Δ {s}_{2} = s ( t + Δ t ) - s ( s ( t ) ) \qquad ( 43 )$$

The value of b in k is expressed by the following formula (44).

$${b}^{k} = {\dot{s}}^{2} ( s ( t ) ) \qquad ( 44 )$$

The value of b in k−1 is expressed by the following formula (45).

$${b}^{k - l} = {\dot{s}}^{2} ( s ( t - Δ t ) ) \qquad ( 45 )$$

The value of b in k+j is expressed by the following formula (46).

$${b}^{k + j} = {\dot{s}}^{2} ( s ( t + Δ t ) ) \qquad ( 46 )$$

The value of b′ in k+j/2 is expressed by the following formula (47).

$${b}^{′ k + \frac{j}{2}} = \frac{{b}^{k + j} - {b}^{k}}{Δ {s}_{2}} \qquad ( 47 )$$

The value of b′ in k−1/2 is expressed by the following formula (48).

$${b}^{′ k - \frac{l}{2}} = \frac{{b}^{k} - {b}^{k - l}}{Δ {s}_{1}} \qquad ( 48 )$$

The value of b′ in k is expressed by the following formula (49).

$${b}^{′ k} = \frac{{b}^{k + j} - {b}^{k - l}}{Δ {s}_{1} + Δ {s}_{2}} \qquad ( 49 )$$

The value of b″ in k is expressed by the following formula (50).

$${b}^{″ k} = 2 \frac{{b}^{′ k + \frac{j}{2}} - {b}^{′ k - \frac{l}{2}}}{Δ {s}_{1} + Δ {s}_{2}} \qquad ( 50 )$$

Therefore, the jerk value of each joint in the new trajectory TR2 is calculated by the formula (51).

$${\overline{q}}_{i}^{k} = \sqrt{{b}^{k}} ( {q}_{i}^{′′′ k} {b}^{k} + \frac{3}{2} {q}_{i}^{″ k} {b}^{′ k} + \frac{1}{2} {q}_{i}^{′ k} {b}^{″ k} ) \qquad ( 51 )$$

As described above, the CPU 401 obtains a dynamic value related to the robot 100 generated by the new trajectory TR2 (new speed command) by using the obtained parameter set PS₆.

In step S124, the CPU 401 determines whether or not the calculated dynamic value satisfies the dynamic restriction. Here, the dynamic value satisfying the dynamic restriction means that the dynamic value falls within the range of the dynamic restriction. In the example of the present embodiment, the CPU 401 determines whether or not the torque value satisfies the joint torque restriction and whether or not the jerk value satisfies the jerk restriction. In the case where the torque value satisfies the joint torque restriction and the jerk value satisfies the jerk restriction, the result of step S124 is YES, and in the case where the torque value does not satisfy the joint torque restriction or the jerk value does not satisfy the jerk value, the result of step S124 is NO.

In the case where the result of step S124 is NO, that is, in the case where the dynamic value does not satisfy the dynamic restriction, in step S126, the CPU 401 changes the cam curve parameter such that the maximum acceleration Aₘₘ becomes lower, and returns to the processing of step S116.

In step S126, the maximum acceleration Aₘₘ can be halved by using a halving method, that is, the maximum acceleration Aₘₘ can be multiplied by ½. The halving method is a root finding algorithm in numerical analysis, and is used for obtaining the solution of a formula. This is a method of obtaining an approximate value of the solution by repeatedly dividing a section where the solution is present into two.

In the case where the result of step S124 is YES, that is, in the case where the dynamic value satisfies the dynamic restriction, the CPU 401 determines in step S128 whether or not the determination on the new trajectory TR2 has been finished. Specifically, whether or not the determination has been finished for all the determination points PJ₁ to PJ_{A} is determined. For example, in the case where an emergency stop command is received, the CPU 401 determines whether or not the determination has been finished from the start point P3 to the end point P4 of the path PT2 to the end of the operation of the robot 100 included in the new trajectory TR2. The end point P4 is an example of a sixth position. The path PT2 is an example of a second path.

In the case where the result of step S128 is NO, that is, in the case where the determination is not finished, in step S130, the CPU 401 sets a position corresponding to a position command that is one time step further in the new trajectory TR2 as a determination point, and returns to the processing of step S120. That is, in the case where the determination on the dynamic value corresponding to the determination point PJ₁ is finished, the determination point PJ₂ is set as the next determination target.

In the case where the result of step S128 is YES, that is, in the case where the determination on all the dynamic values corresponding to the determination points PJ₁ to PJ_{A} is finished, in step S131, the CPU 401 increments the count value of a counter counting the number of generated trajectories by 1.

That is, since the speed command generated in step S116 satisfies the dynamic restriction, in step S131, the count value of the number of generated speed commands satisfying the dynamic restriction is incremented by 1.

Next, in step S132, the CPU 401 determines whether or not the count value of the counter has reached a predetermined value (designated value). The predetermined number is the number of generated trajectories satisfying the dynamic restriction. That is, trajectories of a number of the predetermined value satisfying the dynamic restriction are generated. The predetermined value is a value (positive integer) stored in a storage device such as the HDD 404 in advance. The predetermined value can be set to an integer of 2 or more, but may be set to 1.

In the case where the result of step S132 is NO, that is, in the case where the count value does not reach the predetermined value, in step S134, the CPU 401 changes the cam curve parameter such that the maximum acceleration Aₘₘ increases, and returns to the processing of step S116. The method for increasing the maximum acceleration Aₘₘ is, for example, a doubling method of doubling the maximum acceleration Aₘₘ.

In the case where the result of step S132 is YES, that is, in the case where the count value has reached the predetermined value, in step S136, the CPU 401 controls the operation of the robot 100 after receiving the emergency stop command, in accordance with one new trajectory TR2 whose dynamic value satisfies the dynamic restriction. The one new trajectory TR2 is an example of a second trajectory. As described above, the CPU 401 controls the robot 100 by switching the trajectory from the trajectory TR1 to the trajectory TR2 at the start point P3 in the case where a predetermined command such as an emergency stop command is received.

As described above, in step S116, one or more new trajectories TR2 (one or more new speed commands) are generated, and as a result of repeating steps S116 to S134, new trajectories (new speed commands) TR2 of a number equal to the predetermined value are extracted from the one or more new trajectories TR2 (one or more new speed commands). Then, in step S136, the operation of the robot 100 is controlled in accordance with the new trajectory TR2 (new speed command) in which the maximum acceleration Aₘₘ is the highest among the extracted new trajectories TR2 (extracted new speed commands). The one or more new trajectories TR2 (one or more new speed commands) are obtained by using one or more cam curves.

For example, in the case where the predetermined value is set to an integer of two or more, a plurality of new trajectories TR2 (plurality of new speed commands) are generated as the one or more new trajectories TR2 (one or more new speed commands). The plurality of new trajectories TR2 (plurality of new speed commands) are obtained by using a plurality of cam curves with different maximum accelerations Aₘₘ. Then, two or more new trajectories TR2 (two or more new speed commands) are extracted as candidates from the plurality of new trajectories TR2 (plurality of new speed commands).

Specifically, for each of the plurality of new trajectories TR2 (plurality of new speed commands), at least one determination point, a plurality of determination points PJ₁ to PJ_{A} in the present embodiment, are set in step S118 and step S130. Then, in step S120, for each of the plurality of determination points PJ₁ to PJ_{A}, one of the plurality of parameter sets PS₁ to PS_{K}, for example, a parameter set PS_{K} assigned to the evaluation point PE_{K} closest to a determination point PJₐ of interest among the plurality of evaluation points PE₁ to PE_{K} is selected. For example, in the case of the determination point PJ₁, the parameter set PS₆ assigned to the evaluation point PE₆ closest to the determination point PJ₁ is selected.

Then, in step S122, on the basis of the selected parameter set PS₆ and the new trajectory TR2 (new speed command), a dynamic value such as a torque value or a jerk value is obtained in the determination point PJ₁. If the dynamic value satisfies the dynamic restriction for each of the determination points PJ₁ to PJ_{A}, the new trajectory TR2 (new speed command) is a candidate trajectory (candidate speed command). Candidate trajectories (candidate speed commands) of a number equal to the predetermined value are extracted.

Then, in step S136, after the start point P3, the robot 100 is controlled in accordance with one new trajectory TR2 (one new speed command) among the two or more new trajectories TR2 (two or more new speed commands) serving as candidates. The one new trajectory TR2 (one new speed command) can be a new trajectory TR2 (new speed command) with the highest maximum acceleration Aₘₘ among the two or more new trajectories TR2 (two or more new speed commands).

To be noted, although in the flowchart illustrated in FIG. 4, the candidate trajectory (candidate speed command) is constantly updated, and the new trajectory TR2 (new speed command) extracted last among the two or more new trajectories TR2 (new speed commands) serving as candidates is used for the control of the robot 100, the configuration is not limited to this. For example, in step S136, one of the two or more new trajectories TR2 (new speed commands) serving as candidates may be selected as a trajectory used for the control of the robot 100.

In the case where the predetermined value is set to 1, one new trajectory TR2 (one new speed command) is selected as a candidate from one or more new trajectories TR2 (one or more new speed commands). To be noted, in the case where the predetermined value is set to 1, the number of new trajectories TR2 (new speed commands) generated in step S116 is 1 or more, but there is a case where only one new trajectory TR2 is generated in step S116 and the one new trajectory TR2 is extracted as the candidate.

To be noted, the CPU 401 may display the generated trajectory TR2 and/or the position where the speed change is completed in the original trajectory TR1 on the user interface, and thus notify the user how much the speed is changed in what kind of trajectory TR2.

As described above, in the present embodiment, the CPU 401 obtains the plurality of parameter sets PS₀ to PS_{K} respectively set for the plurality of evaluation points PE₀ to PE_{K} in the path PT1. Then, in the case where a predetermined command such as an emergency stop command is received during the operation of the robot 100, the CPU 401 obtains one or more new trajectories TR2 (one or more new speed commands). Then, the CPU 401 selects a predetermined parameter set from the plurality of parameter sets PS₀ to PS_{K}. The CPU 401 obtains a dynamic value by using the selected predetermined parameter set for one or more new trajectories TR2 (one or more new speed commands). The CPU 401 controls the operation of the robot 100 after receiving the predetermined command, in accordance with one new trajectory TR2 (one new speed command) whose dynamic value satisfies the dynamic restriction among the one or more new trajectories TR2 (one or more new speed commands). According to such processing, in the case where a predetermined command such as an emergency stop or SLS is received by the control apparatus 400, the CPU 401 of the control apparatus 400 can generate an optimum trajectory satisfying a dynamic restriction such as a torque restriction or a jerk restriction in a short calculation time. In addition, by shortening the speed change time, the lifetime of the robot 100 can be elongated. As described above, according to the present embodiment, a technique advantageous for reducing the load on the robot 100 can be provided.

More specifically, a predetermined parameter set to be used for the calculation of the dynamic value in the determination points PJ₁ to PJ_{A} is selected from the plurality of parameter sets PS₀ to PS_{K} in accordance with each of the determination points PJ₁ to PJ_{A} downstream of a position in the path PT1 where a command such as an emergency stop command is received. The selected predetermined parameter set can be a parameter set associated with the evaluation point closest to the corresponding determination point among the plurality of evaluation points PE₀ to PE_{K}.

After the new trajectory TR2 (new speed command) is obtained, the CPU 401 controls the robot 100 such that the control point moves in the path PT2 from the start point P3 to the end point P4 illustrated in FIG. 5D in accordance with the new trajectory TR2 (updated speed command). The path PT2 can be a part of the path PT1. The start point P3 can be a position in the path PT1 where the CPU 401 has received the predetermined command. The end point P4 can be a position in the path PT1 between the start point P3 and the end point P2. In the present embodiment, in the case where a predetermined command such as an emergency stop command is received during the operation of the robot 100, the CPU 401 decelerates the robot 100 and stops the operation of the robot 100 in accordance with the new trajectory TR2 (new speed command).

### Other Modification Examples

The present disclosure is not limited to the embodiment described above, and can be modified in many ways within the technical concept of the present disclosure. In addition, the effects described in the present embodiment are merely enumeration of the most preferable effects, and are not limited to the present disclosure.

Although a case where the robot arm 101 is an orthogonally articulated robot arm has been described in the embodiment described above, the configuration is not limited to this. For example, the robot arm 101 may be a horizontally articulated robot arm, a parallel link robot arm, or an orthogonal robot. In addition, the present disclosure is applicable to a machine that can automatically perform extension, contraction, bending, vertical movement, horizontal movement, turning, or a composite motion of these on the basis of information in a storage device provided in a control apparatus.

As described above, according to the present disclosure, a technique advantageous for reducing the load on the robot is provided.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063611, filed Apr. 8, 2025, which is hereby incorporated by reference herein in its entirety.

What is claimed is:

1. A control method for controlling an operation of a robot in accordance with a speed command for the robot moving in a path, the control method comprising:
in a case where a predetermined command is received while the robot is operating in accordance with the path, obtaining a parameter set in accordance with a first position downstream of a position where the robot is positioned when the predetermined command is received;
obtaining a new speed command satisfying a dynamic restriction on a basis of the obtained parameter set; and
controlling, in accordance with the new speed command, the operation of the robot after receiving the predetermined command.

2. The control method according to claim 1,
wherein a plurality of parameter sets are respectively set for a plurality of second positions in the path and each include at least one parameter used for obtaining a dynamic value related to the robot,
wherein the parameter set is obtained in accordance with the first position from the plurality of parameter sets respectively set for the second positions in the path,
wherein the dynamic value about the robot resulting from the new speed command is obtained by using the obtained parameter set, and
wherein the new speed command is obtained such that the dynamic value satisfies the dynamic restriction.

3. The control method according to claim 1, wherein the new speed command is obtained such that an operation speed of the robot transitions from an original speed to a target speed, the original speed being the operation speed of the robot when the predetermined command is received.

4. The control method according to claim 2, wherein the parameter set obtained in accordance with the first position is a parameter set corresponding to a second position closest to the first position among the second positions.

5. The control method according to claim 2,
wherein the new speed command is one of a plurality of new speed commands, and
wherein the dynamic value is obtained for each of the plurality of new speed commands.

6. The control method according to claim 1,
wherein the path and the speed command are included in a trajectory of the robot, and
wherein the robot is controlled in accordance with the trajectory.

7. The control method according to claim 1,
wherein the path is a path from a third position to a fourth position, and
wherein the robot is controlled to move from a fifth position to a sixth position in the path in accordance with the new speed command after receiving the predetermined command,
wherein the fifth position is a position in the path where the robot is positioned when the predetermined command is received, and
wherein the sixth position is a position in the path between the fifth position and the fourth position.

8. The control method according to claim 1, wherein after receiving the predetermined command, the robot is decelerated and the operation of the robot is stopped in accordance with the new speed command.

9. The control method according to claim 1, wherein the predetermined command is a command that is issued in a case where a predetermined button is operated.

10. The control method according to claim 1, wherein the predetermined command is a command that is issued in response to detection by a predetermined sensor.

11. The control method according to claim 1, wherein the dynamic restriction includes at least one of a joint torque restriction of a torque acting on a joint of the robot, a joint angular velocity restriction of an angular velocity of the joint of the robot, a joint angular acceleration restriction of an angular acceleration of the joint of the robot, a jerk restriction of a jerk of the joint of the robot, a speed restriction of a speed of a predetermined portion of the robot, and an acceleration restriction of an acceleration of a predetermined portion of the robot.

12. The control method according to claim 1, wherein the new speed command is obtained by using a cam curve.

13. The control method according to claim 5,
wherein the plurality of new speed commands are obtained by using a plurality of cam curves, and
wherein the plurality of cam curves are obtained by using a halving method of halving a maximum acceleration and/or a doubling method of doubling the maximum acceleration.

14. A control method for controlling an operation of a robot in accordance with a trajectory of the robot moving in a path, the control method comprising:
in a case where a predetermined command is received while the robot is operating in accordance with the path, obtaining a parameter set in accordance with a first position downstream of a position where the robot is positioned when the predetermined command is received;
obtaining a new trajectory satisfying a dynamic restriction on a basis of the obtained parameter set; and
controlling, in accordance with the new trajectory, the operation of the robot after receiving the predetermined command.

15. A control apparatus configured to control an operation of a robot in accordance with a speed command for the robot moving in a path, the control apparatus being configured to:
in a case where a predetermined command is received while the robot is operating in accordance with the path, obtain a parameter set in accordance with a first position downstream of a position where the robot is positioned when the predetermined command is received;
obtain a new speed command satisfying a dynamic restriction on a basis of the obtained parameter set; and
control, in accordance with the new speed command, the operation of the robot after receiving the predetermined command.

16. A robot system comprising:
a robot; and
the control apparatus according to claim 15 configured to control the robot.

17. A method for manufacturing a product, the method comprising manufacturing the product by using a robot controlled by the control method according to claim 1.

18. A non-transitory computer-readable recording medium storing a program for causing a computer to execute the control method according to claim 1.
